(19) United States
(12) Patent Application Publication
(10) Pub. No.: US 2025/0390712 A1
(43) Pub. Date: Dec. 25, 2025

(54) LARGE LANGUAGE MODEL VALIDATION

(71) Applicant: Kahun Medical Ltd, Givatayim (IL)

(72) Inventors: Tal Yaakov GOLDBERG, Even Yehuda (IL); Michal TZUCHMAN KATZ, Tel Aviv (IL); Shahar Yechezkel OVADIA, Ashkelon (IL); Joseph MERMELSTEIN, Kfar Saba (IL); Avi GURFINKEL, Tel Aviv (IL); Gilad KEHAT, Rehovot (IL)

(73) Assignee: Kahun Medical Ltd, Givatayim (IL)

(21) Appl. No.: 18/752,954

(22) Filed: Jun. 25, 2024

(51) Int. Cl. G06N 3/0455

(52) U.S. Cl. CPC G06N 3/0455

(57) ABSTRACT

There is provided a computer implemented method of validating a text generated by a large language model (LLM), comprising: extracting a structured statement from the text generated by the LLM in response to an input, the structured statement comprising a first concept, a second concept, and a relational term defining a relationship between the first concept and the second concept, searching using the structured statement, a dataset including a plurality of pre-validated structured statements, and validating the text generated by the LLM in response to a match between the structured statement and at least one of the plurality of pre-validated structured statements of the dataset.

### BACKGROUND

The present invention, in some embodiments thereof, relates to large language models (LLM) and, more specifically, but not exclusively, to systems and methods for validation of a large language model.

Validating a large language model (LLM) using standard approaches may involve a series of rigorous tests and evaluations to ensure that the model performs well across various tasks, is reliable, and aligns with ethical and safety standards.

### SUMMARY

According to a first aspect, a computer implemented method of validating a text generated by a large language model (LLM), comprises: extracting a structured statement from the text generated by the LLM in response to an input, the structured statement comprising a first concept, a second concept, and a relational term defining a relationship between the first concept and the second concept, searching using the structured statement, a dataset including a plurality of pre-validated structured statements, and validating the text generated by the LLM in response to a match between the structured statement and at least one of the plurality of pre-validated structured statements of the dataset.

According to a second aspect, a system for validating of a text generated by a large language model (LLM), comprises: at least one processor executing a code for: extracting a structured statement from the text generated by the LLM in response to an input, the structured statement comprising a first concept, a second concept, and a relational term defining a relationship between the first concept and the second concept, searching using the structured statement, a dataset including a plurality of pre-validated structured statements, and validating the text generated by the LLM in response to a match between the structured statement and at least one of the plurality of pre-validated structured statements of the dataset.

According to a third aspect, a non-transitory medium storing program instructions for validating of a text generated by a large language model (LLM), which when executed by at least one processor, cause the at least one processor to: extract a structured statement from the text generated by the LLM in response to an input, the structured statement comprising a first concept, a second concept, and a relational term defining a relationship between the first concept and the second concept, search using the structured statement, a dataset including a plurality of pre-validated structured statements, and validate the text generated by the LLM in response to a match between the structured statement and at least one of the plurality of pre-validated structured statements of the dataset.

In a further implementation form of the first, second, and third aspects, the extracting, the searching, and the validating are iterated for each of a plurality of structured statements extracted from the text, wherein the text is validated when each of the plurality of structured statements is matched to a corresponding pre-validated structured statement in the dataset.

In a further implementation form of the first, second, and third aspects, the extracting, the searching, and the validating are performed prior to providing the text generated by the LLM in response to the input, wherein the text and an indication of validation of the text are provided in response to the input.

In a further implementation form of the first, second, and third aspects, further comprising: identifying at least one of a mismatch indicating a contradiction between the structured statement and at least one of the plurality of pre-validated structured statements, no match between the structured statement and any of the plurality of pre-validated structured statements, and non-validating the text in response to the identified mismatch and/or no match.

In a further implementation form of the first, second, and third aspects, further comprising generating an indication for the structured statement indicating one of: confirmation in response to the match, contradiction in response to the mismatch, and no match.

In a further implementation form of the first, second, and third aspects, when a pre-validated statement is “if A then B”, the structured statement comprising “A causes B” or “B because of A” is validated, and the structured statement comprising “Not B and A” is identified as the contradiction.

In a further implementation form of the first, second, and third aspects, further comprising in response to the non-validation of the text, generating an adaptation of the input, feeding the adapted input into the LLM to obtain an adapted text, and iterating the extracting, the searching and the validating for the adapted text.

In a further implementation form of the first, second, and third aspects, the generating the adapted input, the feeding the adapted input, the extracting, and the searching, are iterated until the text is validated.

In a further implementation form of the first, second, and third aspects, further comprising: in response to the non-validation of the text, identifying a pre-validated structured statement correlated with the structured statement, and instructing the LLM to re-write using the correlated pre-validated structured statement instead of the structured statement, and correcting context and/or other impacted content accordingly.

In a further implementation form of the first, second, and third aspects, further comprising prompting the LLM to re-write the text according to the matching structured statement.

In a further implementation form of the first, second, and third aspects, each pre-validated structured statement is associated with an indication of a validated source, and further comprising providing the text generated by the LLM and the indication of the validated source in response to the match.

In a further implementation form of the first, second, and third aspects, the text comprises a plurality of structured statements, wherein each of the plurality of structured statements is matched with a pre-validated structured statement associated with a respective source used for the validation, and further comprising mapping a plurality of validated sources to the plurality of structured statements, and providing the mapping.

In a further implementation form of the first, second, and third aspects, the text comprises medical content, the first concept and/or the second concept of the pre-validated structured statements included in the dataset comprise medical parameters, the relational term comprises a clinical relationship, and the pre-validated structured statements are validated by medical literature.

In a further implementation form of the first, second, and third aspects, further comprising providing an indication of quality of the validation of the pre-validated structured statement according to a type of clinical evidence used for generation of the pre-validated structured statement, selected from: double blind randomized control trial, observational study, meta-analysis, case report, retrospective study, and expert opinion.

In a further implementation form of the first, second, and third aspects, the plurality of pre-validated structured statements are associated with a likelihood parameter, and wherein the match comprises a partial match when the likelihood parameter of the structured statement does not match the likelihood parameter of at least one of the plurality of pre-validated structured statements.

In a further implementation form of the first, second, and third aspects, further comprising: in response to a match between the structured statement and the at least one of the plurality of pre-validated structured statements, identifying a contradiction by at least one of: (i) matching the first concept and the second concept and detecting an opposite relation of the relational term, (ii) detecting that the second concept is an opposite of the first concept, and providing an indication of the contradiction.

In a further implementation form of the first, second, and third aspects, further comprising: in response to a match between the structured statement and the at least one of the plurality of pre-validated structured statements, identifying mismatch of the relational term, and at least one of: querying the LLM if the matching at least one of the plurality of pre-validated structured statements confirms or contradicts the structured statement, and using natural language processing approaches to extract a structure of the structured statement, and compare the structure to the matching at least one of the plurality of pre-validated structured statements to determine whether the matching at least one of the plurality of pre-validated structured statements confirms or contradicts the structured statement.

In a further implementation form of the first, second, and third aspects, further comprising: in response to a match between the structured statement and the at least one of the plurality of pre-validated structured statements, and at least one of: (i) querying the LLM if the matching at least one of the plurality of pre-validated structured statements confirms or contradicts the structured statement, and (ii) asking the LLM to extract at least one statement from the structured statement, for each extracted statement: using natural language processing approaches or asking the LLM or another LLM to create a new structured statement from the extracted statement, and comparing the new structured statement to the matching at least one of the plurality of pre-validated structured statements to determine whether the matching at least one of the plurality of pre-validated structured statements confirms or contradicts the structured statement, for each at least one of the plurality of pre-validated structured statements matched to the structured statement, asking the LLM or another LLM if the extracted statement is validated or contradicted by the respective pre-validated structured statement.

In a further implementation form of the first, second, and third aspects, searching comprises searching for combinations of linked pre-validated structured statements, and the match is between the structured statement and a combination of two or more linked pre-validated structured statements.

In a further implementation form of the first, second, and third aspects, further comprising creating the plurality of pre-validated structured statements by extracting structured statements from pre-validated text.

In a further implementation form of the first, second, and third aspects, further comprising creating a new pre-validated structured statement from a combination of two or more linked pre-validated structured statements.

In a further implementation form of the first, second, and third aspects, further comprising creating at least one pre-validated structured statement by analyzing a plurality of records, and extracting the first concept, the second concept and the relational term from the plurality of records.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for validating a text generated by a LLM using a dataset of pre-validated structured statements, in accordance with some embodiments of the present invention;

FIG. 2 is a flowchart of a method of validating a target structured statement extracted from a response by a LLM using a dataset of pre-validate structured statements, in accordance with some embodiments of the present invention; and

FIG. 3 is a flowchart of a method of generating a dataset of pre-validate structured statements for validating a target structured statement extracted from a response by a LLM, in accordance with some embodiments of the present invention.

### DETAILED DESCRIPTION

The present invention, in some embodiments thereof, relates to large language models (LLM) and, more specifically, but not exclusively, to systems and methods for validation of a large language model.

An aspect of some embodiments of the present invention relates to systems, methods, computing devices, and/or code instructions for validating a response generated by a LLM in response to a prompt. The response and/or prompt may be human readable text. One or more structured statements (also referred to herein as target structured statements) are extracted from the response generated by the LLM in response to an input of the prompt. Each structured statement includes a first concept, a second concept, and a relational term defining a relationship between the first concept and the second concept. A dataset including multiple pre-validated structured statements is respectively searched using each respective target structured statement. The dataset may be created in advance by extracting structured statements from pre-validated text, for example, articles in well-respected medical journals, randomized clinical trials, and published clinical guidelines. The response generated by the LLM is validated in response to a match between the target structured statement and at least one of the pre-validated structured statements of the dataset.

At least some embodiments address the technical problem of validating a response generated by a LLM. At least some embodiments improve the technology of LLM, by providing a mechanism for validating the response of the LLM. At least some embodiments improve upon prior approaches of validating the response of the LLM.

LLM are widely used. A user enters a prompt into the LLM and receives a response. The user cannot be sure whether the response is factually correct or not. The response may be erroneous, due to, for example, errors in the training data itself that was used to train the LLM, and/or due to an error by the LLM in generating the response (even when the training dataset is correct).

The problem is especially challenging in the context of medicine, where much invalid medical literature exists, and where the user is looking for responses that are based on sound medical advice, such as randomized clinical trial, clinical guidelines by medical organizations, and opinions by well-respected clinicians.

At least some embodiments address the technical problem of providing a reference to a data source for validating a response of the LLM. At least some embodiments improve the technology of LLM, by providing a reference to a data source for validating a response of the LLM. At least some embodiments improve upon prior approaches of validating the LLM by providing a reference to a data source for validating a response of the LLM.

The prompt generated by the LLM is not linked to a data source. The LLM generates the prompt as a standalone entity, without being able to point to a data source for validating whether the prompt is correct or not. The LLM is trained on a vast amount of training data derived from different data sources. During training, links to the data sources are not maintained, since the LLM does not include a mechanism for storing such data and linking it to a generated response. For example, weights of a neural network implementation of the LLM are adjusted in order to generate a response to a prompt, but are not designed to link to the data sources which are implicitly used to generate the prompt.

One example of an existing attempt to validate prompts generated by the LLM is a “double check response” button that may be pressed by a user to check the prompt generated by the LLM. This approach searches the internet to find content that is likely similar to, or likely different from, statements generated by the LLM. The integrity of the approach is based on the integrity of the search (which not be accurate), and/or of the search results (which may display data from erroneous data sources). There is no good way to verify the reference page found by the search is actually relevant for the text generated by the LLM. For example, the search result may just be a webpage mentioning a similar phrase to the one in the response generated by the LLM, while the context is completely different. Moreover, this approach does not work in more complex cases, for which the search results are irrelevant.

The technical problem is compounded by the standard approach where the LLM is treated as a black box, which is not transparent, for example, users are denied access to the training dataset and/or the internal workings of the LLM.

At least some embodiments address the aforementioned technical problem(s), and/or improve the aforementioned technical field(s), and/or improve upon the aforementioned prior approach(es) for validating a response generated by a LLM in response to a prompt. One or more target structured statements are extracted from the response generated by the LLM in response to an input of the prompt. Each structured statement includes a first concept, a second concept, and a relational term defining a relationship between the first concept and the second concept. A dataset including multiple pre-validated structured statements is respectively searched using each respective target structured statement. The dataset may be created in advance by extracting structured statements from pre-validated text, for example, articles in well-respected medical journals, randomized clinical trials, and published clinical guidelines. The response generated by the LLM is validated in response to a match between the target structured statement and at least one of the pre-validated structured statements of the dataset.

In an example, a doctor sends a prompt to the LLM as follows: “A 24 y/o male with sudden severe back pain, fever and rash. What is he likely to suffer from? What lab tests should be ordered?” The LLM generates the following response: “Likely Conditions: Pyelonephritis (kidney infection) Spinal infection (e.g., vertebral osteomyelitis, discitis) Other systemic infections (e.g., meningitis, if there are neurological symptoms) Recommended Lab Tests: Complete blood count (CBC) Urinalysis and urine culture Blood cultures Renal function tests Inflammatory markers (ESR, CRP) Imaging of the spine if suspected spinal involvement (MRI or CT) Lumbar puncture if meningitis is suspected.” At least some embodiments described herein may add a layer on top of the response by the LLM stating that: 1. 72% of patient with Kidney infection report severe back pains 2. CRP has specificity of 90% to detect pyelonephritis in patients suffering from back pain 3. There is no medical evidence in the literature for the relation between Kidney infection and Rash Each of these statements is derived from the dataset of pre-validated structured statements described herein, and therefore is clinically validated.

In another example, a user asks the LLM for a recommendation of a good Italian restaurant in New York City which is open today until at least 22:00. The LLM generates a list of candidate restaurants. The dataset is used to verify whether the generated recommended restaurants exist in the specified location and are open during the defined time. The LLM may generate erroneous data, for example, due to being trained on outdated data (e.g., restaurants have closed since) and/or trained on erroneous data (e.g., reviews posted online for Italian restaurants by the same name but in a different city). The dataset may include verified correct data, such as using up to date restaurant listings and/or reviews of the correct restaurants.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

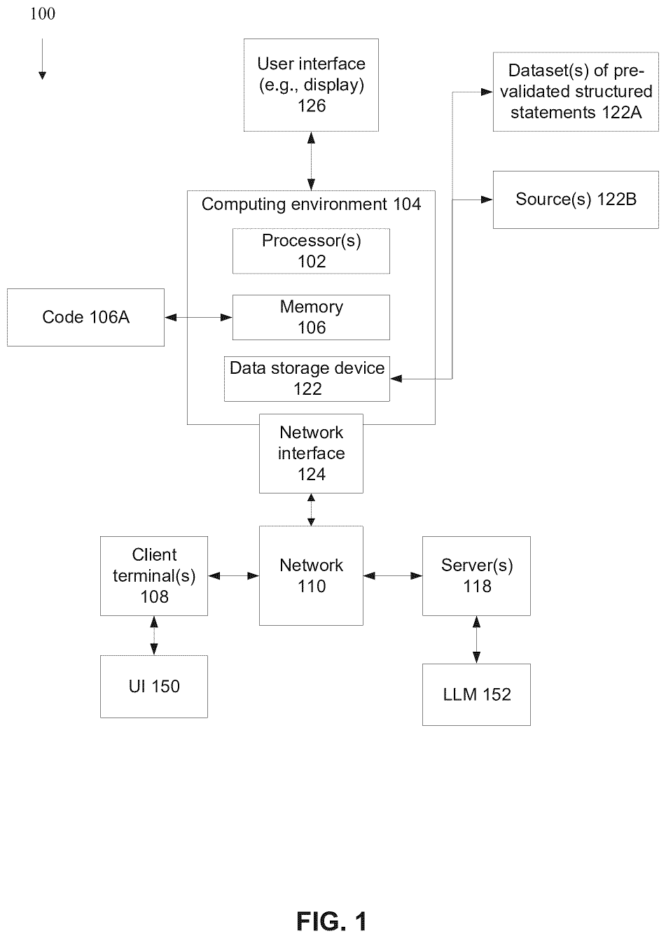

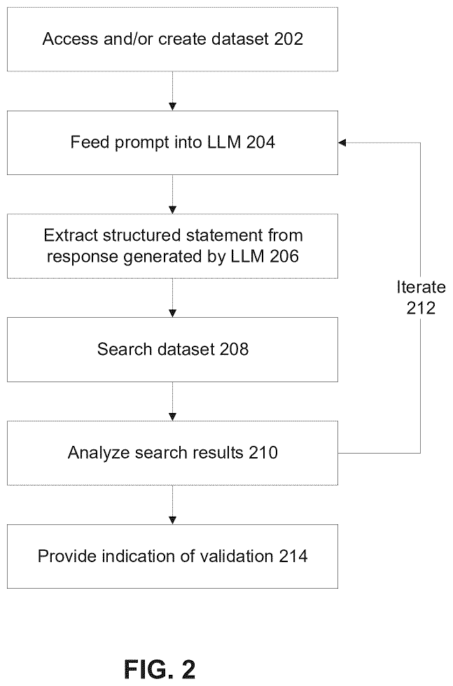

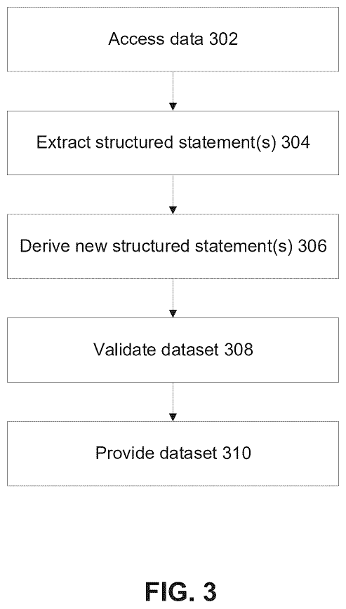

Reference is now made to FIG. 1, which is a block diagram of components of a system 100 for validating a text generated by a LLM 152 using a dataset 122A of pre-validated structured statements, in accordance with some embodiments of the present invention. Reference is also made to FIG. 2, which is a flowchart of a method of validating a target structured statement extracted from a response by a LLM using a dataset of pre-validate structured statements, in accordance with some embodiments of the present invention. Reference is also made to FIG. 3, which is a flowchart of a method of generating a dataset of pre-validate structured statements for validating a target structured statement extracted from a response by a LLM, in accordance with some embodiments of the present invention.

System 100 may implement the acts of the method described with reference to FIGS. 2-3, by processor(s) 102 of a computing environment 104 executing code instructions stored in a memory 106 (also referred to as a program store).

Computing environment 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Computing environment 104 may extract one or more target structured statements from a prompt, which may be obtained from a client terminal 108 such as entered by a user via a user interface (UI) 150. Computing environment 104 may search dataset 122A of pre-validated structured statements for the target structured statement(s). In response to one or more matches, computing environment 104 may provide an indication of validity of the prompt to the client terminal 108, for example, for presentation within UI 150.

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for validating responses generated by one or more LLMs 152 (e.g., one or more of the acts described with reference to FIGS. 2 and/or FIG. 3). Services may be provided, for example, to one or more client terminals 108 over network 110 (e.g., which may provide the prompt to the LLM 152), and/or to one or more server(s) 118 over network 110. Server(s) 118 may host one or more LLM 152, where generation of a response by LLM 152 in response to an input of a prompt, such as by client terminal(s) 108 optionally via UI 150, triggers the process for validating the response using dataset 122A. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web sited hosted by computing environment 104. For example, a user uses client terminal 108 (e.g., via UI 150) to enter a prompt into LLM 152 hosted by server 118, such as to send a clinical question for a certain patient. Server 118 may access computing environment 104 for validating the response generated by LLM 152. Computing environment 104 may perform the validation using dataset 122A. The results of the validation and optional instructions for the user to follow may be presented within UI 150 on a display of client terminal 108.

Dataset 122A may be created by computing environment 104, and/or by another computing environment, as described herein.

In another example, Computing environment 104 may be implemented as a standalone device (e.g., kiosk, client terminal, smartphone) that include locally stored code instructions 106A that implement one or more of the acts described with reference to FIGS. 2 and/or FIG. 3, for locally validating responses generated by LLM 152. For example, for validating responses of a customized LLM 152 which may be trained for patients of a specific health center which may be running on the standalone device. LLM 152 and/or dataset(s) 122A may be locally stored on computing environment 104. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIG. 2 and/or FIG. 3 when executed by hardware processor(s) 102.

Computing environment 104 may include a data storage device 122 for storing data, for example, dataset(s) 122A of pre-validated structured statements, and/or source(s) 122C (e.g., link to the source and/or a file of the actual source) used to derive the pre-validated structured statements of the dataset, as described herein. Data storage device 122 may be implemented as, for example, a memory, a local hard-drive, virtual storage, a removable storage unit, an optical disk, a storage device, and/or as a remote server and/or computing cloud (e.g., accessed using a network connection).

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 include and/or are in communication with one or more user interfaces 126 which may present UI 150, which may present the results of the validation and any instructions to follow. Exemplary user interfaces 126 include, for example, one or more of, a touchscreen, a display, gesture activation devices, a keyboard, a mouse, and voice activated software using speakers and microphone.

Referring now back to FIG. 2, at 202, a dataset of pre-validated structured statements is created and/or accessed. An exemplar approach for creating the dataset is described with reference to FIG. 3.

At 204, a prompt is fed into the LLM.

Optionally, the prompt is in text format, optionally human readable text.

The prompt may be provided manually by a user, for example, by typing using a keyboard, and/or by speaking into a microphone and converting the audio to text. Alternatively or additionally, the prompt may be automatically generated by a process (e.g., another machine learning model). For example, the process analyzes medical reports written by physicians, and automatically extracts statements from the report, which are fed into the LLM as prompts.

At 206, a response is generated by the LLM in response to the input of the prompt. One or more structured statements are extracted from the response.

The term target structured statement may refer to the structured statement extracted from the response generated by the LLM.

Each structured statement may be in a format that corresponds to the format of the pre-validated structured statements stored in the dataset, for example, a triplet defined as (entity1, entity2, relation), or a quadruple defined as (entity1, entity2, relation, and likelihood), where entity1 denotes a first concept, entity2 denotes a second concept, relation denotes a relational term, and likelihood denotes the probability.

A concept may include one or more words, such as a phrase, for example, an entity, a state, a token, a field, and the like.

Each structured statement may be in a format that may be classified as true or false.

A relational term is applied to the first concept and the second concept may be evaluated to be true or false. For example, “is better than”, “is not so good as”, “must be”, and the like.

Structured statements may be extracted from the response, for example, using natural language processing (NLP) approaches, another LLM trained to extract structured statements, and the like.

Alternatively or additionally, structured statements are extracted from other sources, for example, from the prompt fed into the LLM that triggered the response, other structured data such as features extracted by analyzing an image generated by the LLM (e.g., in an image of a child next to a cow on a field of grass, the structured data may be a text description of the image).

An example of structured statement is “The patient presented with fever and therefore may have Influenza.”

At 208, one or more (optionally each) target structured statements are used to search the dataset.

The dataset may be searched, for example, for direct matches of one or more of the first concept, the second concept, and the relational term. Such search may be done using an index approach, by looking up the target structured statement in the index. In another example, the dataset may be searched for similarity, such as by computing a correlation between the target structured statement and the pre-validated structured statements of the dataset. Correlations above a threshold may be selected and/or highest correlation(s) may be selected as matches. The correlation may be computed for a vector representation extracted from each of the target structured statement and the pre-validated structured statement, for example, using a word to vector process that maps text to vectors. The correlation may be computed as a Euclidean distance between the vectors. Lowest distance(s) may be selected as matches.

Optionally, the search done over combinations of linked pre-validated structured statements. The match may be between the target structured statement and a combination of two or more linked pre-validated structured statements.

At 210, the results of the search over the dataset may be analyzed.

Results may be analyzed per target structured statement, and/or for multiple target structured statements extracted from the prompt, which may provide a result for the prompt as a whole.

Example of search results and/or outcome of the analysis include:
A match between the target structured statement and one or more of the pre-validated structured statements. The match indicates that the target structured statement exists in the dataset, or may be derived from the dataset. The match may confirm that the target structured statement is true/correct. The target structured statement may be validated in response to the match.
A match between the target structured statement and one or more of the pre-validated structured statements may indicate a contradiction between the target structured statement and one or more of the pre-validated structured statements. The contradiction may be identified by matching the first concept and the second concept, and detecting an opposite relation, difference of the relation term. Alternatively or additionally, the contradiction may be identified by detecting that the second concept is an opposite of and/or contradicts the first concept. For example, a restaurant address cannot be at a first street (according to the target structured statement) and a second street (according to the pre-validated structured statement) at the same time. In another example, a patient cannot have low fever and high fever at the same time. In yet another example, a restaurant which is open weekdays only cannot be opened on the weekend. In yet another example, “lying only” and “sitting only”, are contradictory since the two cannot occur simultaneously in a person. The contradiction may indicate that the target structured statement is false/incorrect and/or that the target structured statement contradicts a fact that may be derived from the dataset. The target structured statement may be non-validated in response to the contradiction.
In an example, the pre-validated statement is: If A then B (if Influenza then Fever). If the target structured statement states: 1. A causes B (Patient has Influenza and therefore must have Fever) or 2. B because of A (patient has Fever and therefore Influenza is suspected), then the dataset pre-validated statement verifies the target structured statement. Alternatively, if the target structured statement is Not B and A (Patient does not have Fever and has Influenza) a more accurate contradiction is obtained.

It is noted that:
1. Probable vs always: If the statement in the pre-validated dataset is probabilistic for example “if A then B with probability 95%” (and not if A then ALWAYS B), the rest of the logic is still valid but should be softened to use terms like probably and likely
2. The case of closed set: Many times you can assume “not B” from the statement “A”.

### Examples

2.1 If the patient has “Mild abdominal pain” (A) the patient clearly has no “Severe abdominal pain” (B).
2.2 If the patient has fever that started 2 days ago (A) the patient does not have Fever lasting for at least a month (B).
2.3 If the patient have low blood pressure (A) the patient does not have high blood pressure (B).
In the aforementioned cases the logic of contradiction may also be applied. i.e., if the pre-validated statement in the dataset is “X causes high blood pressure” and the patient has low or normal blood pressure a contradiction is obtained.
No match between the target structured statement and any of the pre-validated structured statements. The lack of match may indicate that the target structured statement is not relevant, and/or does not exist in the dataset, without necessarily indicating whether it is true or false. The target structured statement may be non-validated in response to the lack of match.
A partial correlation and/or partial match between the target structured statement and one or more of the pre-validated structured statements. And/or a match between the target structured statement and one or more pre-validated structured statements which are associated with a likelihood parameter, such a probability. The partial correlation may indicate that the target structured statement is not definitive, such as is not a full match or a full contradiction, but rather a likelihood. The partial correlation may be associated with a probability greater than 0 and less than 100. The probability may represented as likely or unlikely according to defined probability ranges. For example, where 90% of patients with Influenza present with fever, the search result for target structured statement “The patient presented with fever and therefore may have Influenza” may be a likelihood of 90%. A contradiction may be detected when the likelihood parameter of the target structured statement does not match the likelihood parameter of the pre-validated structured statement(s). For example, the likelihood of fever with Influenza in the target structured statement is 20%, while the likelihood of fever with Influenza in the dataset is 90%.

Some examples of the outcome of the search and/or analysis are provided:
For the target structured statement “the patient presented with fever and therefore may have celiac” the generated indication may be: confirming correctness of the target structured statement based on a match with the pre-validated structured statement (enity1: fever, entity2: celiac, relation: causes).
For the target structured statement “the patient presented with fever and therefore celiac should be ruled out” the generated indication may be a contradiction based on the pre-validated structured statement fact (enity1: fever, entity2: celiac, relation: causes).
When the target structured statement is confirmed by at least a single pre-validated structured statement of the dataset, the target structured statement may be associated with the indication “Confirm”.
When the target structured statement contradicts a single pre-validated structured statement of the dataset, the target structured statement may be associated with the indication “Contradict”.
When the target structured statement is both confirmed and contradicted, an indication indicating the dual confirmation may be generated.
When the target structured statement cannot be confirmed or contradicted, an indicating that the target structured statement does not exists in the dataset may be generated.

At 212, one or more features described with reference to 204-210 may be iterated.

Optionally, the features are iterated for each one of multiple target structured statements extracted from the response of the LLM. The response may be validated when each of the target structured statements is matched to at least one corresponding pre-validated structured statement in the dataset. Other rules may be applied for validating the response, such as likelihood of matches being above a threshold, and/or significance of the contradictions. For example, some contradictions may be irrelevant in the context of the response as a whole, and therefore do not impact the validity of the response as a whole.

Optionally, the iterations are performed on the target structured statements extracted from the response of the LLM prior to providing the response generated by the LLM, such as prior to presentation of the response on a display of a client terminal of a user that provided the prompt. The response generated by the LLM may be provided when the target structured statements are validated by the search on the dataset. Optionally, in response to the non-validation of the response, such as one or more target structured statements are not validated by the search on the dataset, an adaptation of the input prompt is generated. The input prompt may be adapted according to the outcome of the search, such as to instruct the LLM re-write the response to avoid including the invalid target structured statements and/or to focus on the validated target structured statements. In another example, in response to the non-validation of the target structured statement, one or more pre-validated structured statements of the dataset correlated with the target structured statement are identified (e.g., contradictory statements). The input prompt may be adapted to instruct the LLM to re-write the response using the correlated pre-validated structured statement instead of the target structured statement (which was non-validated), and/or for correcting context and/or other impacted content of the response accordingly. The adapted input prompt is fed into the LLM to obtain an adapted response. The adapted response is processed as described herein for validation (i.e., extraction of target structured statements and searching on the dataset). In yet another example, the input prompt may be adapted to instruct the LLM to re-write the response to accentuate the validated target structured statements. The process of adapting the prompt, obtaining the adapted response, extracting target structured statements, and searching on the dataset, may be iterated until a validated version of the adapted response is obtained.

Alternatively, in response to validation of the response, the LLM (or another LLM) may be prompted to re-write the response according to the pre-validated structured statements of the dataset matching to the target structured statements of the response. The LLM (or another LLM) may re-write the response to further accentuate validated facts.

Alternatively or additionally, even in the case of a match between the target structured statement and one or more of the plurality pre-validated structured statements, it may be uncertain if the target structured statement is validated by or contradicts the matching pre-validated structured statement. For example, the match may be between the first and second concepts while the relational term is different. In another example, the match between the first and second concepts may be partial, such as associated with a probability. For matches associated with uncertainty, the LLM (or another LLM) may be queried by asking if the matching pre-validated structured statement(s) confirms or contradicts the target structured statement. Alternatively or additionally, the LLM (or another LLM) may be asked to extract at least one statement from the target structured statement. For each extracted statement, natural language processing approaches may be used, or the LLM or another LLM may be queried, to create a new structured statement from the extracted statement. The new structured statement may be compared to the matching pre-validated structured statement(s) to determine whether the matching pre-validated structured statement(s) confirms or contradicts the target structured statement and/or the new structured statement and/or the extracted structured statement. The comparison may be more accurate with the new structured statement rather than the target structured statement, such as when the new structured statement is shorter and/or more similar in terms of context and/or language to the pre-validated structured statements. Alternatively or additionally, for each of the pre-validated structured statements matched to the target structured statement, the LLM or another LLM may be queried by asking if the extracted statement is validated or contradicted by the respective pre-validated structured statement.

Alternatively or additionally, it may be unclear if a pre-validated structured statement confirms or contradicts the target structured statement. For example, a match between the first and second concepts of the target structured statement and the pre-validated structured statements is detected, while a mismatch between the relational terms is identified. To resolve the uncertainty, the LLM (or another LLM) may be queried to determine if the identified matching pre-validated structured statement(s) confirms or contradicts the target structured statement. Alternatively or additionally, to resolve the uncertainty, natural language processing and/or other approaches may be used to extract a structure of the target structured statement. The extracted structure may be compared to the matched pre-validated structured statements. A mismatch of the extracted structure may indicate that the matching pre-validated structured statements contradicts the target structured statement, while a match of the extracted structure may indicate a confirmation of the target structured statement.

At 214, one or more indications are generated and/or provided. The indication(s) may be, for example, presented on a display of a client terminal from which the prompt to the LLM was obtained.

The indication may be per target structured statement extracted from the response of the LLM, and/or for an aggregation of multiple structured statements extracted from the response of the LLM.

Examples of indications for the target structured statement(s) include: confirmation in response to the match, contradiction in response to the mismatch, and no match.

The indication(s) may be presented visually within a user interface, optionally within a graphical user interface (GUI). For example, text of the response from which target structured statements are extracted may be highlighted. A balloon pointing to each highlighted text may present the indication. A user may click on the balloon to obtain additional details, for example, the extracted target structured statement, a validated data, and the like.

In embodiments in which pre-validated structured statements of the dataset are associated with an indication of a validated source used to derive the pre-validated structured statement, the validated source may be provided. For example, a link to the validated source is presented.

Optionally, an indication of quality of the validation of the target structured statement(s) is obtained from the corresponding matching pre-validated structured statement(s) in the dataset. The quality may be according to the validated source from which the pre-validated structured statement(s) is derived, such as according to a type of clinical evidence used for generation of the pre-validated structured statement. Examples include: double blind randomized control trial (e.g., high quality), observational study (e.g., medium quality), meta-analysis (e.g., high quality), case report (e.g., low quality), retrospective study (e.g., medium quality), and expert opinion (e.g., low quality).

Optionally, a mapping of validated sources to one or more target structured statements of the response is generated and/or provided. The validated sources are matched to the pre-validated structured statements of the dataset, where the pre-validated structures statements may be extracted from the corresponding validated sources. The mapping may be presented as, for example, links within balloon pointing to the different target structured statements which may be indicated on the response. The user may click on the link to access the validated source for the different target structured statements extracted from the response.

Referring now back to FIG. 3, at 302, data, optionally text, is accessed. Examples of data include articles, studies (e.g., randomized control trial, retrospective study, observational study, other statistical studies), scientific knowledge, webpages, publications, etc.

The text is assumed to be pre-validated based on the selection of source data known to be valid.

Each text may include multiple pre-validated statements.

The pre-validated statement may be obtained, for example, by one or more of:
Manual process by editors.
Automatic extraction from texts and/or tables, for example, using natural language processing (NLP) approaches or other methods.
Creating one or more pre-validated structured statement by analyzing records. For example, automatic extraction from a large dataset. For example, a patient records database may include records for 1000 patients with influenza out of which 700 have fever as well. The following pre-validated statement may be automatically extracted into the format described with reference to feature 304: (entity1: Influenza, entity2: Fever, likelihood: 70%).

At 304, multiple pre-validated structured statements are extracted from the text.

The structured statement may include a first concept, a second concept, a relational term defining a relationship between the first concept and the second concept, and optionally a probability that the relational term applied to the first concept and the second concept is correct.

Each structured statement may be defined by a common structured format, for example, a triplet defined as (entity1, entity2, relation), or a quadruple defined as (entity1, entity2, relation, and likelihood), where entity1 denotes the first concept, entity2 denotes the second concept, relation denotes the relational term, and likelihood denotes the probability. Examples of structured statements include:
The validated statement “Google acquired Waze” may be represented as (entity1: “Google”, entity2: “Waze”, relation: “acquired”).
The validated statement “Influenza is causing Fever” may be represented as (entity1: “Influenza”, entity2: “Fever”, relation: “causing”)
The validated statement “50% of patients with Influenza present with Fever” may be represented as (entity1: “Influenza”, entity2: “Fever”, relation: “presentWith”, likelihood: 50%)
The validated statement “Smokers are 2 times more likely to have lung cancer vs non-smokers” may be represented as (entity1: “smokers”, entity2: “lung cancer”, likelihood: 2×).

Different types of pre-validated structured statements may be extracted for creating multiple datasets, where each dataset is for a certain domain, for example, medical, history, art, and the like. The different datasets may correspond to different LLM, which may be specialized for different domains. Each specialized LLM may correspond to a specialized dataset in the domain of the LLM. Alternatively, a single multi-domain dataset is created and/or accessed, optionally for a single multi-domain LLM.

In the case of a dataset for a medical domain, the first concept and/or the second concept of the pre-validated structured statements included in the dataset may include medical parameters, the relational term may be a clinical relationship, and the pre-validated structured statements are validated by medical literature. Examples of medical parameters include diseases, symptoms, risk factors, and lab results.

Optionally, the source data used to derive the pre-validated structured statements may be assigned a quality rating, such as according to a type of clinical evidence used for generation of the pre-validated structured statement. Examples include: double blind randomized control trial (e.g., high quality), observational study (e.g., medium quality), meta-analysis (e.g., high quality), case report (e.g., low quality), retrospective study (e.g., medium quality), and expert opinion (e.g., low quality).

At 306, one or more new pre-validated structured statements may be derived from the existing pre-validated structured statement. A new pre-validated structured statement may be derived from a combination of two or more linked pre-validated structured statements.

Examples of approaches for deriving new pre-validated structured statements from existing pre-validated structured statements include:
If Influenza is causing Fever (structured statement 1) and Fever is causing Chills (structured statement 2) the structured statement that Influenza is causing Chills may be derived.
If “Viral respiratory infection” is causing “cough” (structured statement 1) and “Influenza” is a type of “Viral respiratory infection” (structured statement 2) the structured statement that Influenza is causing cough may be derived.
If Covid19 is causing “loss of smell” with high probability (structured statement 1) and “loss of smell” is a rare symptom (structured statement 2) the structured statement that patients with loss of smell are likely to have Covid19 may be derived (e.g., using Bayes law).
It is noted that the derivation may be done offline or online (e.g., upon identifying a structured statement in the text which is to be verified).

At 308, the validity of the dataset may be verified using one or more approaches.

When the dataset is created by extraction from text such as medical literature, one or more of the following approaches may be used:
Sample a number of random pre-defined statements out of the dataset, and match them against known valid sources, such as literature, experts, etc.
More sophisticated sampling methods can be used to verify different sub-domains of the database.
A model may be trained to ask if a statement is stated in an article, leading to automated verification of the dataset.

When the dataset is created by deriving statements by analyzing records (or other data), verification may not be required, based on the assumption that the records are true, and the automated analysis devices valid statements.

At 310, the generated dataset(s) is provided.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant LLMs will be developed and the scope of the term LLM is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of validating a text generated by a large language model (LLM), comprising:
extracting a structured statement from the text generated by the LLM in response to an input, the structured statement comprising a first concept, a second concept, and a relational term defining a relationship between the first concept and the second concept;
searching using the structured statement, a dataset including a plurality of pre-validated structured statements; and
validating the text generated by the LLM in response to a match between the structured statement and at least one of the plurality of pre-validated structured statements of the dataset.

2. The computer implemented method of claim 1, wherein the extracting, the searching, and the validating are iterated for each of a plurality of structured statements extracted from the text, wherein the text is validated when each of the plurality of structured statements is matched to a corresponding pre-validated structured statement in the dataset.

3. The computer implemented method of claim 1, wherein the extracting, the searching, and the validating are performed prior to providing the text generated by the LLM in response to the input, wherein the text and an indication of validation of the text are provided in response to the input.

4. The computer implemented method of claim 1, further comprising:
identifying at least one of a mismatch indicating a contradiction between the structured statement and at least one of the plurality of pre-validated structured statements, no match between the structured statement and any of the plurality of pre-validated structured statements; and
non-validating the text in response to the identified mismatch and/or no match.

5. The computer implemented method of claim 4, further comprising generating an indication for the structured statement indicating one of: confirmation in response to the match, contradiction in response to the mismatch, and no match.

6. The computer implemented method of claim 4, wherein when a pre-validated statement is “if A then B”, the structured statement comprising “A causes B” or “B because of A” is validated, and the structured statement comprising “Not B and A” is identified as the contradiction.

7. The computer implemented method of claim 4, further comprising in response to the non-validation of the text, generating an adaptation of the input, feeding the adapted input into the LLM to obtain an adapted text, and iterating the extracting, the searching and the validating for the adapted text.

8. The computer implemented method of claim 7, wherein the generating the adapted input, the feeding the adapted input, the extracting, and the searching, are iterated until the text is validated.

9. The computer implemented method of claim 4, further comprising:
in response to the non-validation of the text, identifying a pre-validated structured statement correlated with the structured statement; and
instructing the LLM to re-write using the correlated pre-validated structured statement instead of the structured statement, and correcting context and/or other impacted content accordingly.

10. The computer implemented method of claim 1, further comprising prompting the LLM to re-write the text according to the matching structured statement.

11. The computer implemented method of claim 1, wherein each pre-validated structured statement is associated with an indication of a validated source, and further comprising providing the text generated by the LLM and the indication of the validated source in response to the match.

12. The computer implemented method of claim 11, wherein the text comprises a plurality of structured statements, wherein each of the plurality of structured statements is matched with a pre-validated structured statement associated with a respective source used for the validation, and further comprising mapping a plurality of validated sources to the plurality of structured statements, and providing the mapping.

13. The computer implemented method of claim 1, wherein the text comprises medical content, the first concept and/or the second concept of the pre-validated structured statements included in the dataset comprise medical parameters, the relational term comprises a clinical relationship, and the pre-validated structured statements are validated by medical literature.

14. The computer implemented method of claim 13, further comprising providing an indication of quality of the validation of the pre-validated structured statement according to a type of clinical evidence used for generation of the pre-validated structured statement, selected from: double blind randomized control trial, observational study, meta-analysis, case report, retrospective study, and expert opinion.

15. The computer implemented method of claim 1, wherein the plurality of pre-validated structured statements are associated with a likelihood parameter, and wherein the match comprises a partial match when the likelihood parameter of the structured statement does not match the likelihood parameter of at least one of the plurality of pre-validated structured statements.

16. The computer implemented method of claim 1, further comprising:
in response to a match between the structured statement and the at least one of the plurality of pre-validated structured statements, identifying a contradiction by at least one of:
(i) matching the first concept and the second concept and detecting an opposite relation of the relational term,
(ii) detecting that the second concept is an opposite of the first concept; and
providing an indication of the contradiction.

17. The computer implemented method of claim 1, further comprising:
in response to a match between the structured statement and the at least one of the plurality of pre-validated structured statements, identifying mismatch of the relational term;
and at least one of:
querying the LLM if the matching at least one of the plurality of pre-validated structured statements confirms or contradicts the structured statement; and
using natural language processing approaches to extract a structure of the structured statement, and compare the structure to the matching at least one of the plurality of pre-validated structured statements to determine whether the matching at least one of the plurality of pre-validated structured statements confirms or contradicts the structured statement.

18. The computer implemented method of claim 1, further comprising:
in response to a match between the structured statement and the at least one of the plurality of pre-validated structured statements, and at least one of:
(i) querying the LLM if the matching at least one of the plurality of pre-validated structured statements confirms or contradicts the structured statement; and
(ii) asking the LLM to extract at least one statement from the structured statement;
for each extracted statement:
using natural language processing approaches or asking the LLM or another LLM to create a new structured statement from the extracted statement, and comparing the new structured statement to the matching at least one of the plurality of pre-validated structured statements to determine whether the matching at least one of the plurality of pre-validated structured statements confirms or contradicts the structured statement;
for each at least one of the plurality of pre-validated structured statements matched to the structured statement, asking the LLM or another LLM if the extracted statement is validated or contradicted by the respective pre-validated structured statement.

19. The computer implemented method of claim 1, wherein searching comprises searching for combinations of linked pre-validated structured statements, and the match is between the structured statement and a combination of two or more linked pre-validated structured statements.

20. The computer implemented method of claim 1, further comprising creating the plurality of pre-validated structured statements by extracting structured statements from pre-validated text.

21. The computing implemented method of claim 1, further comprising creating a new pre-validated structured statement from a combination of two or more linked pre-validated structured statements.

22. The computer implemented method of claim 1, further comprising creating at least one pre-validated structured statement by analyzing a plurality of records, and extracting the first concept, the second concept and the relational term from the plurality of records.

23. A system for validating of a text generated by a large language model (LLM), comprising:
at least one processor executing a code for:
extracting a structured statement from the text generated by the LLM in response to an input, the structured statement comprising a first concept, a second concept, and a relational term defining a relationship between the first concept and the second concept;
searching using the structured statement, a dataset including a plurality of pre-validated structured statements; and
validating the text generated by the LLM in response to a match between the structured statement and at least one of the plurality of pre-validated structured statements of the dataset.

24. A non-transitory medium storing program instructions for validating of a text generated by a large language model (LLM), which when executed by at least one processor, cause the at least one processor to:
extract a structured statement from the text generated by the LLM in response to an input, the structured statement comprising a first concept, a second concept, and a relational term defining a relationship between the first concept and the second concept;
search using the structured statement, a dataset including a plurality of pre-validated structured statements; and
validate the text generated by the LLM in response to a match between the structured statement and at least one of the plurality of pre-validated structured statements of the dataset.
